(19) United States
(12) Patent Application Publication
(10) Pub. No.: US 2022/0305794 A1
(43) Pub. Date: Sep. 29, 2022

(54) LIQUID SELECTING METHOD, LIQUID EJECTING APPARATUS, AND NON-TRANSITORY COMPUTER-READABLE STORAGE MEDIUM STORING COMPUTER PROGRAM

(71) Applicant: Seiko Epson Corporation, Tokyo (JP)

(72) Inventors: Atsushi TOYOFUKU, Shiojiri-shi (JP); Toshiro MURAYAMA, Fujimi-machi (JP)

(21) Appl. No.: 17/656,765

(22) Filed: Mar. 28, 2022

(30) Foreign Application Priority Data
Mar. 29, 2021 (JP) 2021-054955

(51) Int. Cl. B41J 2/175; B41J 2/045

(52) U.S. Cl. CPC B41J 2/17503; B41J 2/04588; B41J 2/04571

(57) ABSTRACT

A liquid selecting method includes an acquiring step of executing first acquisition processing for each of a plurality of first liquid candidates, the first acquisition processing being processing of acquiring first information about a first ejection characteristic of a liquid to be ejected from a liquid ejecting head when a driving waveform is applied to a driving element of the liquid ejecting head, and a liquid selecting step of selecting one or more liquids to be ejected from the liquid ejecting head based on the first information and at least some of the plurality of first liquid candidates.

The present application is based on, and claims priority from JP Application Serial Number 2021-054955, filed Mar. 29, 2021, the disclosure of which is hereby incorporated by reference herein in its entirety.

### BACKGROUND

### 1. Technical Field

The present disclosure relates to a liquid selecting method, a liquid ejecting apparatus, and a non-transitory computer-readable storage medium storing a computer program.

### 2. Related Art

There is a known method of determining parameters that define a waveform of a driving signal, based on a result acquired by ejecting ink drops and measuring ejection characteristics. According to the technique described in JP-A-2010-131910, a plurality of driving signals having respective different parameters that define the driving waveform are prepared. Then, with using one of the plurality of driving signals, ink drops are simultaneously ejected from a plurality of nozzles. The simultaneous ejection of ink drops using one driving signal is performed with varying the number of nozzles. Such processing is performed for each of the driving signals. Then, when ink drops are simultaneously ejected from nozzles with varying the number thereof, parameters of the driving signal having the smallest deviation in ejection speed of the ink drops are adopted as parameters of a driving signal to be actually used in printing. As a result, ink drops are stably ejected from each nozzle irrespective of the number of nozzles that simultaneously eject the ink drops.

users may select ink for reproducing a certain color from among inks of a plurality of manufacturers and apply the selected ink to the printer. One manufacture may provide compatible similar-colored inks. The plurality of inks may differ in characteristics such as viscosity and surface tension. In using inks having various characteristics such as viscosity and surface tension, preferred ejection characteristics, for example, ejection amount, ejection speed, the amount of subdrop, or the like are not always achieved even at the application of a driving signal confirmed to achieve preferred ejection characteristics for some inks. For this reason, there is a demand for the technique of identifying the ink that achieves desirable ejection characteristic in a head of the printer to be used by the users.

### SUMMARY

An embodiment of the present disclosure provides a liquid selecting method of selecting a liquid to be ejected from a liquid ejecting head. The liquid selecting includes: an acquiring step of executing, for each of a plurality of first liquid candidates, first acquisition processing of acquiring first information about a first ejection characteristic of a liquid when a driving waveform is applied to a driving element of the liquid ejecting head; and a liquid selecting step of selecting, based on the first information and at least some of the plurality of first liquid candidates, one or more liquids to be ejected from the liquid ejecting head.

### BRIEF DESCRIPTION OF THE DRAWINGS

FIG. 1 is a block diagram illustrating the configuration of a printer and a computer in a printing system according to a first embodiment.

FIG. 2 is a perspective view illustrating a part of the configuration of the printer.

FIG. 3 is a sectional view illustrating the section of an ink ejecting head, taken along the direction perpendicular to a subscanning direction Ds.

FIG. 4 is a view illustrating a driving waveform W of a driving signal COM.

FIG. 5 is a flow chart illustrating a method of determining the ink to be applied to the printer 1.

FIG. 6 is a flow chart illustrating a method of determining the ink to be applied to the printer 1 according to a second embodiment.

FIG. 7 is a flow chart illustrating a method of determining the ink to be applied to the printer 1 according to a third embodiment

### DESCRIPTION OF EXEMPLARY EMBODIMENTS

### A. First Embodiment

### A1. Configuration of Printing System

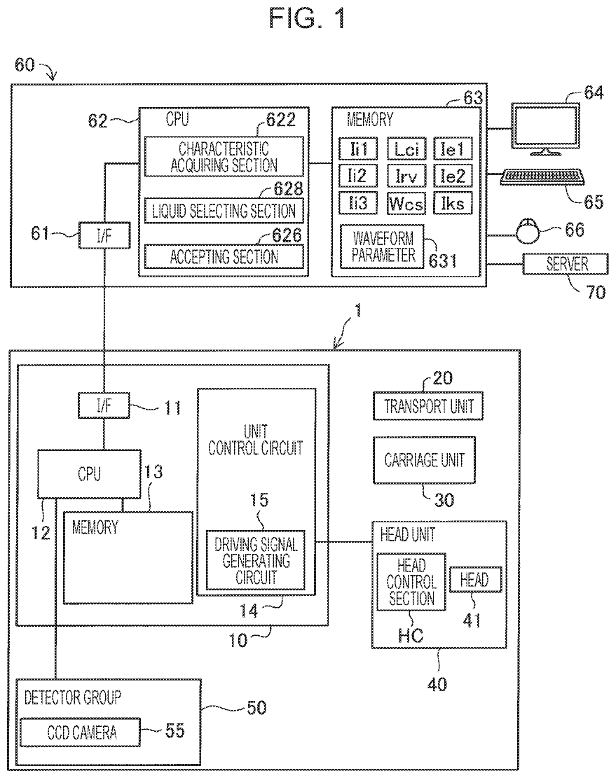

FIG. 1 is a block diagram illustrating the configuration of a printer 1 and a computer 60 in a printing system according to a first embodiment. The printing system includes the printer 1 and the computer 60.

The printer 1 drives driving elements, thereby ejecting ink drops from nozzles to form, based on printing data, an image on a printing medium PM. The printer 1 includes a controller 10, a transport unit 20, a carriage unit 30, a head unit 40, and a detector group 50.

The controller 10 is a control unit that controls the printer 1. The controller 10 includes an interface section 11, a CPU 12, a memory 13, and a unit control circuit 14.

The interface section 11 transmits and receives data between the printer 1 and the computer 60. The CPU 12 is an arithmetic processing unit that controls the entire printer 1. The memory 13 includes an auxiliary memory that stores a computer program executed by the CPU 12 and a main memory that serves as a working area. The CPU 12 that is a processor loads the program stored in the auxiliary memory into the main memory and executes the program to perform various functions. The main memory is preferably a nonvolatile memory but may be a volatile memory. Both of the nonvolatile memory and the volatile memory may be suitably used as the auxiliary memory.

The unit control circuit 14 controls each of the units of the printer 1 according to an instruction from the CPU 12. The unit control circuit 14 includes a plurality of driving signal generating circuits 15. The driving signal generating circuits 15 generate driving signals COM including a plurality of driving waveforms W that occur at certain intervals. For facilitating understanding of the technique, in FIG. 1, the driving signal generating circuits 15 are represented as one component.

The transport unit 20 transports the printing medium PM to a printable location and transports the printing medium PM during printing by a transport amount of a predetermined pattern. The carriage unit 30 moves an ink ejecting head 41 and an ink cartridge attached to a carriage 31 in a direction that crosses the transport direction of the printing medium PM. In the present specification, the moving direction of the ink ejecting head 41 is referred to as a “main scanning direction Dm”. The transport direction of the printing medium PM is referred to as a “subscanning direction Ds”.

The head unit 40 ejects an ink supplied from the ink cartridge onto the printing medium PM. The head unit 40 has the ink ejecting head 41 and a head control section HC. A plurality of nozzles Nz are provided at a lower face of the ink ejecting head 41. The ink ejecting head 41 includes a plurality of driving elements PZT. The driving element PZT is specifically, a piezo element. One nozzle Nz is provided with one driving element PZT. The driving elements PZT are driven by the application of the driving signal COM. Due to the driving of the driving elements PZT, the ink ejecting head 41 ejects ink drops from the nozzles Nz. The driving element PZT is a piezoelectric element made of lead zirconate titanate in this embodiment and, however, may be a piezoelectric element made of any material other than lead zirconate titanate or a heat generating element.

Based on printing data, the head control section HC controls whether or not the driving waveform W of the driving signal COM is applied to the driving element PZT corresponding to each nozzle Nz. When the driving waveform W is applied to the driving element PZT corresponding to one nozzle Nz, the amount of ink corresponding to the driving waveform W is ejected from the nozzle Nz to form a dot on the printing medium PM. On the contrary, when the driving waveform W is not applied to the driving element PZT corresponding to one nozzle Nz, no ink drop is ejected from the nozzle Nz.

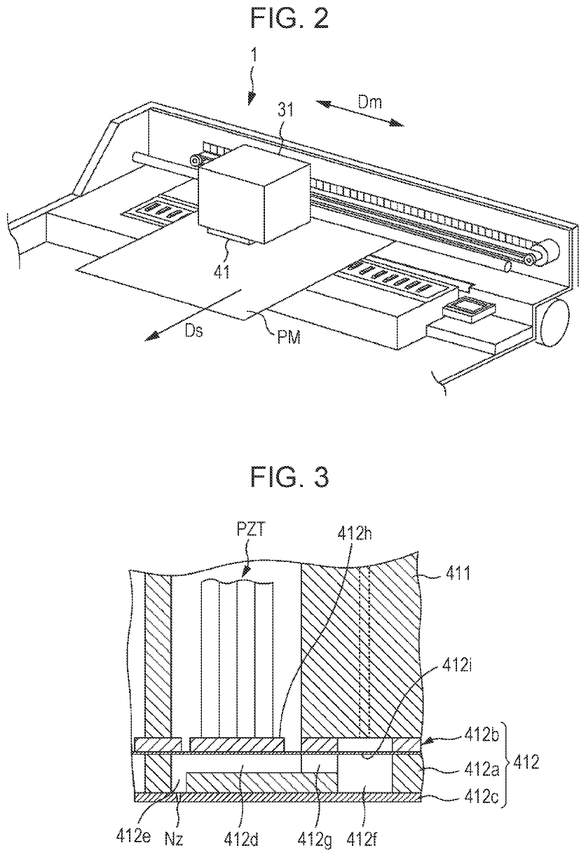

FIG. 2 is a perspective view illustrating a part of the configuration of the printer 1. The printer 1 can perform dot forming processing of causing the ink ejecting head 41 moving in the main scanning direction Dm to intermittently eject ink drops to form dots on the printing medium PM. The printer 1 can perform transport processing of transporting the printing medium PM in the subscanning direction Ds. The printer 1 alternatively repeats the dot forming processing and the transport processing, thereby forming a dot on each location on the printing medium PM to form an image.

The detector group 50 monitors the status of the printer 1 (Refer to the lower stage in FIG. 1). According to an output signal from the detector group 50, the controller 10 controls each section constituting the printer 1. The detector group 50 includes a CCD camera 55.

The CCD camera 55 acquires the image of the ink drops ejected from the ink ejecting head 41 and outputs image data to the CPU 12. The CCD camera 55 can capture a still image as well as a moving image. In this specification, the “image” includes the still image and the moving image.

The CCD camera 55 is used to capture an image for acquiring information indicative of the ejection characteristic as described below and however, any component capable of acquiring information indicative of the ejection characteristic may be used in place of the CCD camera 55. For example, an electronic scale may be used in place of the CCD camera 55 to acquire information indicative of the ejection characteristic including ejection amount and so on.

The computer 60 transmits the printing data to the printer 1. The computer 60 transmits parameters indicative of a driving waveform W of the driving signal of the driving element to the printer 1. The computer 60 includes an interface section 61, a CPU 62, a memory 63, a display 64, a keyboard 65, and a mouse 66.

The display 64 is controlled by the CPU 62 and outputs an image. The user operates the keyboard 65 and the mouse 66 to input an instruction to the CPU 62.

The interface section 61 transmits and receives data between the computer 60 and the printer 1. The memory 63 includes an auxiliary memory that stores a computer program executed by the CPU 62 and a main memory that serves as a working area. The CPU 62 that is a processor loads the program stored in the auxiliary memory into the main memory and executes the program to perform various functions.

For example, the CPU 62 performs the function of acquiring information indicating the ejection characteristic that is the characteristic of the ink ejected from the ink ejecting head 41. More specifically, based on the image of ink drops, which is acquired by the CCD camera 55 of the printer 1, the CPU 62 can acquire the ejection amount of the ink ejected from one nozzle Nz by the ejecting operation of the driving element PZT, the ejection speed of the ink ejected from the nozzle Nz, and the total amount of subdrops of the ink ejected from one nozzle Nz by the ejecting operation of the driving element PZT. The CPU 62 performs the function of selecting ink to be ejected from the ink ejecting head 41.

FIG. 3 is a sectional view illustrating the section of the ink ejecting head 41, taken along the direction perpendicular to the subscanning direction Ds. The ink ejecting head 41 has a case 411, a flow channel unit 412, the plurality of driving elements PZT. The case 411 stores the plurality of driving elements PZT. The flow channel unit 412 is bonded to a lower face of the case 411.

The flow channel unit 412 has a flow channel forming plate 412a, an elastic plate 412b, and a nozzle plate 412c.

The flow channel forming plate 412a has a groove that function as a pressure chamber 412d, a through port that function as a nozzle communicating port 412e, a through port that function as a common ink chamber 412f, and a groove that function as an ink supply channel 412g. The plurality of nozzles Nz included in one nozzle row are provided with one common ink chamber 412f. One nozzle Nz is provided with a set of the ink supply channel 412g, the pressure chamber 412d, and the nozzle communicating port 412e. In the ink ejecting head 41, the ink is supplied to the pressure chamber 412d through the common ink chamber 412f and the ink supply channel 412g. The ink in the pressure chamber 412d is ejected from the nozzle Nz through the nozzle communicating port 412e.

The elastic plate 412b has an island 412h to which a tip of the driving element PZT is bonded. Then, an elastic area formed of an elastic film 412i is formed around the island 412h.

The nozzle plate 412c is a plate in which the plurality of nozzles Nz are formed. A yellow nozzle array for ejecting a yellow ink, a magenta nozzle array for ejecting a magenta ink, a cyan nozzle array for ejecting a cyan ink, and a black nozzle array for ejecting a black ink are formed at a nozzle Nz face that is one face of the nozzle plate 412c. Each of the nozzle arrays is constituted of 180 nozzles Nz aligned at predetermined intervals in the subscanning direction Ds. The nozzle arrays are aligned in the main scanning direction Dm. FIG. 3 is a sectional view illustrating the section perpendicular to the subscanning direction Ds. In the unit control circuit 14, one driving signal generating circuit 15 is provided for one nozzle array.

The plurality of driving elements PZT are formed as a plurality of comb-like elements. A circuit board equipped with the head control section HC applies the driving signal COM to the driving elements PZT. The driving elements PZT expand or contract depending on the potential of the driving signal COM. When the driving element PZT contracts, the island 412h deforms toward the driving element PZT. When driving element PZT expands, the island 412h deforms toward the pressure chamber 412d. As a result, the pressure in the pressure chamber 412d changes such that ink drops are ejected from the nozzles Nz. One driving signal generating circuit 15 is provided for one nozzle array. Thus, the driving signal COM generated by a certain driving signal generating circuit 15 is commonly applied to driving elements PZT of all nozzles Nz that belong to the nozzle array corresponding to the driving signal generating circuit 15. However, the head control section HC determines whether or not the driving waveform W of the driving signal COM is applied to each of the driving elements PZT.

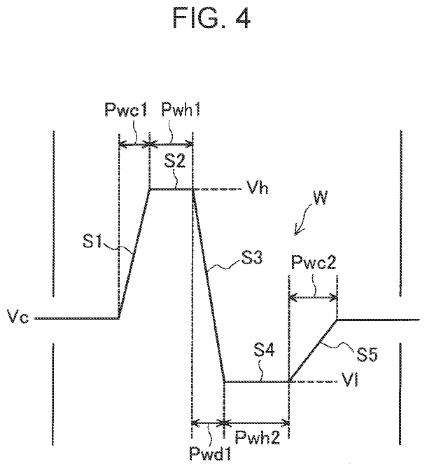

FIG. 4 is a view illustrating the driving waveform W of the driving signal COM. In the driving signal COM, the driving waveform W illustrated in FIG. 4 occurs at a certain cycle. The driving waveform W has a first expansion element S1 that raises the potential from an intermediate potential Vc to a highest potential Vh, a first holding element S2 that holds the highest potential Vh, a contraction element S3 that lowers the potential from the highest potential Vh to a lowest potential V1, a second holding element S4 that holds the lowest potential V1, a second expansion element S5 that raises the potential from the lowest potential V1 to the intermediate potential Vc.

In the state where the intermediate potential Vc is applied to the driving elements PZT, no driving elements PZT expand or contract. The volume of the pressure chamber 412d in the state where the intermediate potential Vc is applied to the driving elements PZT is referred to as a “reference volume”.

From the state where the intermediate potential Vc is applied to the driving elements PZT, when the first expansion element S1 of the driving signal COM is applied to the driving elements PZT, the driving elements PZT contract in the longitudinal direction. As a result, the volume of the pressure chamber 412d increases (Refer to FIG. 3). When the first holding element S2 of the driving signal COM is applied to the driving elements PZT, the contracted state of the driving elements PZT is maintained. At this time, the expanded state of the pressure chamber 412d is also maintained. When the contraction element S3 of the driving signal COM is applied to the driving elements PZT, the driving elements PZT extend from the contracted state. As a result, the volume of the pressure chamber 412d decreases. The pressure of the ink in the pressure chamber 412d increases, thereby causing the nozzles Nz to eject ink drops. After that, when the second holding element S4 of the driving signal COM is applied to the driving elements PZT, the expanded state of the driving elements PZT and the contracted state of the pressure chamber 412d are maintained. When the second expansion element S5 is applied to the driving elements PZT, the volume of the pressure chamber 412d returns to the reference volume.

The period when the first expansion element S1 occurs is referred to as a “first expansion period Pwc1”. The period when the first holding element S2 occurs is referred to as a “first holding period Pwh1”. The period when the contraction element S3 occurs is referred to as a “contraction period Pwd1”. The period when the second holding element S4 occurs is referred to as a “second holding period Pwh2”. The period when the second expansion element S5 occurs is referred to as a “second expansion period Pwc2”. The first expansion period Pwc1, the first holding period Pwh1, the contraction period Pwd1, the second holding period Pwh2, and the second expansion period Pwc2 are parameters that define the shape of the driving waveform W of the driving signal COM.

### A2. Determination of Liquid

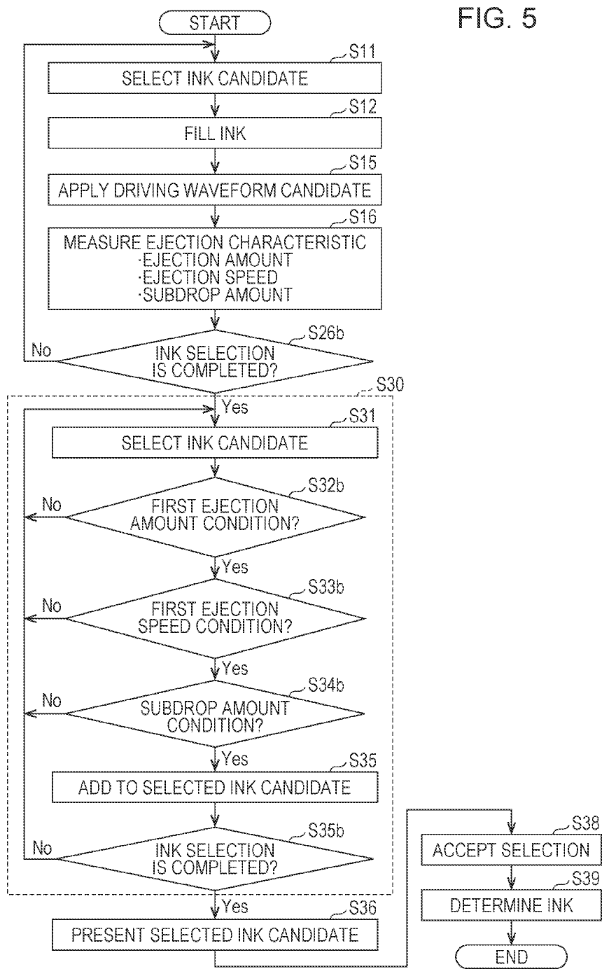

FIG. 5 is a flow chart illustrating a method of determining the ink to be applied to the printer 1. In response to an instruction from the user, mainly the CPU 62 of the computer 60 controls each section of the computer 60 and the printer 1 to execute the processing of the ink determining method in FIG. 5. Through the processing illustrated in FIG. 5, the liquid that is supplied to the printer 1 and ejected from the ink ejecting head 41 is determined.

In Step S11, the user selects one ink candidate from among a plurality of ink candidates Lci previously prepared. The plurality of ink candidates Lci are inks that can be replaced with each other to be supplied to the ink ejecting head 41 and ejected from the nozzles Nz. According to this embodiment, the plurality of ink candidates Lci previously prepared are inks for estimation. For example, the plurality of ink candidates Lci are a plurality of inks supplied as a “cyan ink” by a plurality of manufacturers.

In Step S12, the user attaches a cartridge of the selected ink to the carriage 31, and fills the ink into the nozzles Nz of the ink ejecting head 41. Specifically, the user operates the keyboard 65 and the mouse 66 via the computer 60 to fill the ink in the printer 1. When the printer 1 includes an input devices such as button and touch panel, the user may operate such input devices to fill ink in the printer 1.

In Step S15, the CPU 62 of the computer 60 instructs the CPU 12 of the printer 1 to execute following processing. The CPU12 controls the unit control circuit 14 to cause the driving signal generating circuit 15 to generate the driving signal COM. Then, the CPU 12 applies the driving signal COM to the driving elements PZT of the ink ejecting head 41. As a result, ink drops of the ink candidate Lci are ejected from the nozzles Nz.

In Step S16, the CPU 12 causes the CCD camera 55 to capture an image of the ink drops ejected from the nozzles Nz according to the driving signal COM. The CPU 12 transmits image data to the computer 60. In Step S15, the CPU 62 of the computer 60 instructs the CPU 12 of the printer 1 to execute the processing in Steps S15, S16.

Based on the image data, the CPU 62 calculates an ejection amount Pwm of the ink candidate Lci ejected from one nozzle Nz of the ink ejecting head 41 by the ejecting operation of the driving element PZT. The ink ejection amount is defined by mass. Since the mass is based on volume and ink density, the ink ejection amount may be defined as volume. The CPU 62 associates information about the ejection amount of the ink candidate Lci with information identifying the ink candidate Lci, and stores the information in the memory 63. The information indicating the ejection amount is referred to as “first information Ii1” (Refer to the right region of the upper stage in FIG. 1). The ejection amount ejected from one nozzle Nz by one ejecting operation of the driving element PZT may be used as the ejection amount Pwm of the ink candidate Lci.

Based on the image data, the CPU 62 calculates an ejection speed Pvm of the ink ejected from the ink ejecting head 41. The ink ejection speed is one mode of “ejection characteristic”. The CPU 62 associates information about the ejection speed of the ink candidate Lci with information identifying the ink candidate Lci, and stores the information in the memory 63. The information indicating the ejection speed is referred to as “second information Ii2” (Refer to the right region of the upper stage in FIG. 1).

Based on the image data, the CPU 62 calculates a total amount Psm of subdrops of the ink candidate Lci ejected from one nozzle Nz of the ink ejecting head 41 by the ejecting operation of the driving element PZT. The total amount of subdrops is defined by the number of subdrops. In this specification, the total amount of subdrops is referred to as a “subdrop amount”. The subdrop amount is one mode of “ejection characteristic”. The CPU 62 associates information indicating the subdrop amount of the ink candidate Lci with information identifying the ink candidate Lci, and stores the information in the memory 63. The information indicating the ejection amount is referred to as a “third information Ii3” (Refer to the right region of the upper stage in FIG. 1).

The first information Ii1 to third information Ii3 refers to the ejection characteristics of the ink candidate Lci ejected from the head unit 40 when a certain driving waveform W is applied to the driving element PZT. The processing of acquiring the first information Ii1 in Steps S15, S16 is referred to as “first acquisition processing” in this specification. The processing of acquiring the second information Ii2 in Steps S15, S16 is referred to as “second acquisition processing” in this specification. The processing of acquiring the third information Ii3 in Steps S15, S16 is referred to as “third acquisition processing” in this specification.

A functional section of the CPU 62, which executes the processing in Steps S15, S16, is illustrated as a characteristic acquiring section 622 in FIG. 1 (Refer to the central region of the upper stage in FIG. 1).

In Step S26b in FIG. 5, the CPU 62 determines whether or not the processing in Steps S15, S16 has been executed for all of the ink candidates Lci to be measured in terms of the ejection characteristic, in other words, the plurality of ink candidates Lci previously prepared. When the processing in Steps S15, S16 has been executed for all of the ink candidates Lci to be measured in terms of the ejection characteristic, the procedure returns to Step S30. When the processing in Steps S15, S16 has not been executed for all of the ink candidates Lci to be measured in terms of the ejection characteristic, the procedure returns to Step S11. In Step S11, one ink candidate Lci for which the processing in Step S16 has not been executed is selected from among the plurality of ink candidates Lci previously prepared and then, the processing in Step S12 and subsequent steps is executed.

In Step S30, the CPU 62 selects the ink to be ejected from the ink ejecting head 41, based on the first information Ii1 to third information Ii3 and the plurality of ink candidates Lci. Step S30 includes Steps S31 to S35.

In Step S31, the CPU 62 selects one ink candidate from among the plurality of ink candidates Lci previously prepared for which the processing in Steps S15, S16 has been executed.

In Steps S32b to S34b, the CPU 62 determines whether or not the ejection characteristics indicated by the first information Ii1 about the selected ink candidate Lci satisfies a predetermined selection condition. Specifically, the CPU 62 executes following processing.

In Step S32b, the CPU 62 determines whether or not the ejection amount indicated by the first information Ii1 satisfies a first ejection amount condition. First, the CPU 62 calculates a value Dw according to a below-mentioned formula. The value Dw represents a difference between the ejection amount that is the ejection characteristic indicated by the first information Ii1 and a target ejection amount that is an ideal ejection characteristic.

Dw=|Pwt−Pwm| (1)

Pwt is the target ejection amount.

Pwm is the ejection amount of the ink candidate Lci, which is indicated by the first information Ii1.

The CPU 62 determines whether or not the selected ink candidate Lci satisfies the first ejection amount condition [Dw≤Thwa]. Thwa is a predetermined threshold, which is a positive number less than Pwt.

The first ejection amount condition [Dw≤Thwa] may be expressed as follows:

[Pwt−Thwa]≤Pwm≤[Pwt+Thwa] (2)

That is, the first ejection amount condition is that the ejection amount falls within a predetermined range [Pwt−Thwa] to [Pwt+Thwa]. By appropriately defining Thwa and executing the processing in Step S32b, the ink achieving the desirable ejection amount can be selected.

In Step S32b, when the ejection speed satisfies the first ejection amount condition, the procedure returns to Step S33b. When the ejection speed does not satisfy the first ejection amount condition, the procedure returns to Step S31.

In Step S33b, the CPU 62 determines whether or not the ejection speed indicated by the second information Ii2 satisfies a first ejection speed condition. First, the CPU 62 calculates a value Dv according to a below-mentioned formula. The value Dv represents a difference between the ejection speed that is the ejection characteristic indicated by the second information Ii2 and a target ejection speed that is an ideal ejection characteristic.

Dv=|Pvt−Pvm| (3)

Pvt is the target ejection speed.

Pvm is the ejection speed of the ink candidate Lci, which is indicated by the second information Ii2.

The CPU 62 determines whether or not the selected ink candidate Lci satisfies the first ejection speed condition [Dv≤Thva]. Thva is a predetermined threshold, which is a positive number less than Pvt.

The first ejection speed condition [Dv≤Thva] may be expressed as follows:

[Pvt−Thva]Pvm[Pvt−FThva] (4)

That is, the first ejection speed condition is that the ejection speed of the selected ink candidate Lci falls within a predetermined range [Pvt−Thva] to [Pvt+Thva]. By appropriately defining Thva and executing the processing in Step S33b, the ink achieving the desirable ejection speed can be selected.

In Step S33b, when the ejection speed satisfies the first ejection speed condition, the procedure returns to Step S34b. When the ejection speed does not satisfy the first ejection speed condition, the procedure returns to Step S31.

In Step S34b, the CPU 62 determines whether or not the subdrop amount Psm indicated by the third information Ii3 satisfies a subdrop amount condition [Psm≤Thsa]. Thsa is a predetermined threshold. By appropriately defining Thsa and executing the processing in Step S34b, the ink having a smaller subdrop amount than that desired by the user can be selected.

In Step S34b, when the subdrop amount satisfies the subdrop amount condition, the procedure returns to Step S35. When the subdrop amount does not satisfy the subdrop amount condition, the procedure returns to Step S31.

In Step S35, the CPU 62 adds the ink candidate Lci selected in Step S31 performed last to a selected ink Iks stored in the memory 63 (Refer to the right region of the upper stage in FIG. 1). When Step S35 is first performed in the processing in FIG. 5, the CPU 62 stores the ink candidate Lci selected in Step S31 performed last as the selected ink Iks in the memory 63 (Refer to the right region of the upper stage in FIG. 1).

In Step S35b, the CPU 62 determines whether or not the processing in Step S32b has been executed for all of the ink candidates Lci previously prepared for which the processing in Steps S15, S16 has been executed. When the processing in Step S32b has been executed for all of the ink candidates Lci, the procedure returns to Step S36. When the processing in Step S32b has not been executed for all of the ink candidates Lci, the procedure returns to Step S31. In Step S31, one ink candidate Lci for which the processing in Step S32b has not been executed is selected from among the plurality of previously prepare ink candidates Lci for which the processing in Steps S15, S16 has been executed and then, the processing in Step S32b and subsequent steps is executed.

By repeating the processing in Steps S31 to S35, among all of the ink candidates Lci previously prepared for which the processing in Steps S15, S16 has been executed, one or more ink candidates Lci having the ejection characteristics indicated by the first information Ii1 to third information Ii3 satisfying the predetermined condition are stored as the selected ink Iks in the memory 63 (Refer to the right region of the upper stage in FIG. 1).

As a result of the processing in Steps S31 to S34b, in Step S35, the ink to be ejected from the ink ejecting head 41 is selected based on the first information Ii1, the second information Ii2, the third information Ii3, and the selected ink Iks that is at least some of the plurality of ink candidates Lci previously prepared. A functional section of the CPU 62, which executes the processing in Step S30, is illustrated as a liquid selecting section 628 in FIG. 1 (Refer to the central region of the upper stage in FIG. 1). The processing in Step S11 to S36 realizes a liquid selecting method of selecting one or more liquids to be ejected from a liquid ejecting head. Through processing after Step S36, the ink to be applied to the printer 1 is determined.

Note that at least one of Step S32b, Step S33b, and Step S34b only needs to be performed and other steps may be omitted.

In Step S36, the CPU 62 presents information indicating one or more ink candidates Lci to be ejected from the ink ejecting head 41, which are selected in Step S30, to the user. The presented ink candidates Lci are inks recommended to be used in the printer 1. Specifically, the CPU 62 displays an indication of the ink candidates Lci included in the selected ink Iks and an indication of the ejection characteristic indicated by the first information Ii1 to third information Ii3 on a display 64. Simultaneously, the CPU 62 displays a prompt to input of selection of the ink candidate Lci from the ink candidates Lci included in the selected ink Iks.

Through such processing, one or more inks can be presented as candidates of the ink to be ejected from the ink ejecting head 41 to the user.

In Step S38, the CPU 62 accepts the input of the selection of the ink candidate Lci from the user viewing Step S36 using the keyboard 65 and the mouse 66. As a result, the input of the selection of one or more ink candidates Lci having the ejection characteristic that satisfies the conditions in Step S32b to S34b from among predetermined the plurality of ink candidates Lci is accepted. A functional section of the CPU 62, which executes the processing in Step S38 is illustrated as an accepting section 626 in FIG. 1 (Refer to the central region of the upper stage in FIG. 1).

In Step S39, the CPU 62 determines the ink candidate Lci selected in Step S36 as the ink to be ejected from the ink ejecting head 41.

According to the ink selecting method in this embodiment, the ink candidates Lci having the excellent ejection amount, ejection speed, and subdrop amount when ejected from the ink ejecting head 41 can be selected as the liquid to be ejected from the ink ejecting head 41 from among the plurality of ink candidates Lci that can be replaced with each other when ejected from the ink ejecting head 41 (Refer to Steps S16, S32b to S34b in FIG. 5).

### A3. Modification Example of First Embodiment

According to the first embodiment, in Step S30 in FIG. 5, the ink candidate is selected based on the first information Ii1 to third information Ii3 that indicate the ejection characteristic. However, the selection of the ink candidate in Step S30 may be further made based on another information. For example, in the processing in Step S30, one or more inks to be ejected from the ink ejecting head 41 may be selected based on previously prepared individual information Ie1, Ie2 associated with the plurality of ink candidates Lci.

For example, the individual information Ie1, Ie2 can be saved in a server 70 on a network that is accessible from the computer 60 (Refer to the right region of the upper stage in FIG. 1). The computer 60 can access the server 70 via the network to acquire the individual information Ie1, Ie2.

The CPU 62 may set a condition for the parameter indicated by the individual information, like the first ejection amount condition and the first ejection speed condition, and select a driving waveform candidate Wci as the ink to be ejected from the ink ejecting head 41 when the condition is satisfied (Refer to the above formulas (2), (4)).

From such aspect, the ink to be ejected from the ink ejecting head 41 can be selected in consideration of information other than the ejection characteristics such as ejection amount and ejection speed.

The individual information Ie1 includes information indicating cost of the associated ink candidates Lci. More specifically, the cost of the ink candidates Lci is price of the ink candidates Lci per unit quantity. The unit quantity of the ink candidates Lci may be unit volume, unit weight, or the amount of ink consumed to fill a predetermined region. Th cost of the ink candidates Lci may be the amount of ink consumed to fill a predetermined region. By referring to the individual information Ie1, the ink to be ejected from the ink ejecting head 41 can be selected in consideration of the cost of the ink candidates Lci.

The individual information Ie2 is an estimation of the associated ink candidates Lci, and includes information indicating an estimation other than the ejection characteristic such as the ejection amount. More specifically, examples of the estimation other than the ejection characteristic include the number or ratio of the ink candidates Lci used in the printers of the same model by other persons, the estimation of the whole ink candidates Lci by purchasers, and individual estimation items of the ink candidates Lci by purchasers. For example, the individual estimation items are drying speed, resistance to offset, and resistance to clogging. By referring to individual information Ie2, the liquid to be ejected from the ink ejecting head 41 can be selected in consideration of estimation other than the ejection characteristic of the ink candidates Lci.

The associated individual information may be used for only a part of the plurality of ink candidates Lci previously prepared.

The ink ejecting head 41 according to this embodiment is also referred to as a “liquid ejecting head”. Ink is also referred to as a “liquid”. The unit control circuit 14 is also referred to as a “driving control section”. The ink candidate Lci to be processed in Step S15 is also referred to as a “first liquid candidate”. Step S30 is also referred to as a “liquid selecting step”. Step S36 is also referred to as a “presenting step”. The ejection amount Pwm is also referred to as a “first ejection characteristic”. The ejection speed Pvm is also referred to as a “second ejection characteristic”.

### B. Second Embodiment

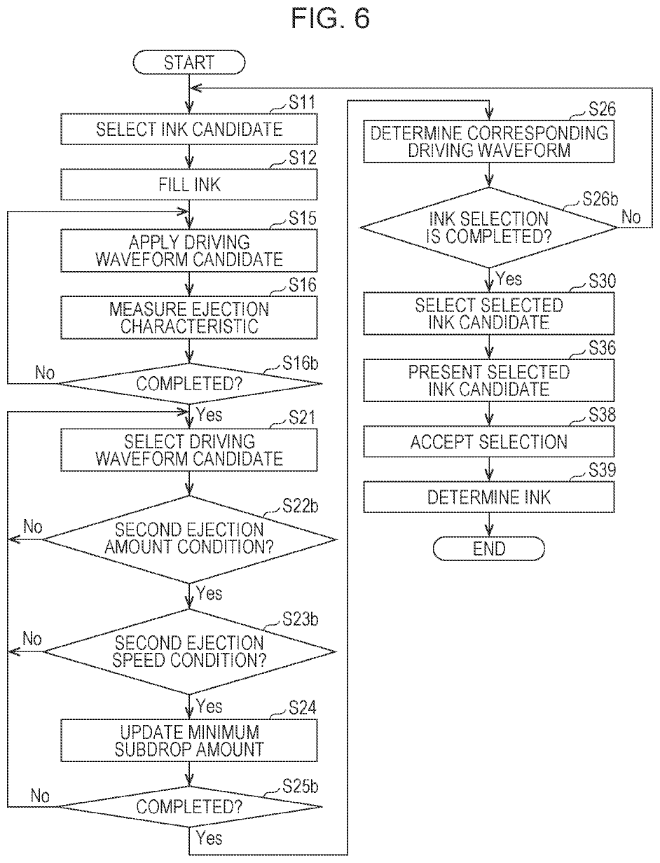

FIG. 6 is a flow chart illustrating a method of determining the ink to be applied to the printer 1 according to a second embodiment. The method in FIG. 6 corresponds to the method according to first embodiment in FIG. 5. According to the second embodiment, the processing in Steps S16b to S26 is executed between Step S16 and Step S26b of the method in FIG. 5. According to the second embodiment, in Step S15 in FIG. 6, in addition to the processing in Step S15 in FIG. 5, further processing is executed. In Step S16 in FIG. 6, in addition to the processing in Step S16 in FIG. 5, further processing is executed. The remainder of the second embodiment is the same as that in the first embodiment.

In Step S15 in FIG. 6, the CPU 62 selects one of the plurality of predetermined driving waveform candidates Wci and transits a set of parameters indicating the selected driving waveform candidates Wci to the printer 1. The plurality of predetermined driving waveform candidates Wci are candidates for the driving waveform W of the driving signal COM applied to the printer 1. A plurality of sets of parameters indicating the driving waveform candidates Wci are previously stored in the memory 63 of the computer 60. The plurality of sets of parameters indicating the plurality of driving waveform candidates Wci are illustrated in “waveform parameters 631” in FIG. 1(Refer to the right region of the upper stage in FIG. 1).

In Step S15, the CPU 12 of the printer 1 controls the unit control circuit 14 to generate the driving signal COM, based on the set of parameters indicating one of the received driving waveform candidates Wci. Then, the CPU 12 applies the driving signal COM to the driving elements PZT of the ink ejecting head 41. The remainder of the processing in Step S15 in FIG. 6 is the same as that of the processing in Step S15 in FIG. 5.

In Step S16, as in the processing in Step S16 in FIG. 5, the first acquisition processing to third acquisition processing is executed to acquire the first information Ii1, the second information Ii2, and the third information Ii3. The CPU 62 associates the first information Ii1, the second information Ii2, and the third information Ii3 with a combination of the ink candidate Lci selected in Step S11 performed last and the driving waveform candidates Wci selected in Step S21 performed last, and stores the associated information in the memory 63. The remainder of the processing in Step S16 in FIG. 6 is the same as that of the processing in Step S16 in FIG. 5.

In Step S16b, it is determined whether or not the processing in Steps S15, S16 has been executed for all of the driving waveform candidates Wci to be measured in terms of the ejection characteristic. When the processing in Steps S15, S16 has been executed for all of the driving waveform candidates Wci to be measured in terms of the ejection characteristic, the procedure returns to Step S21. When the processing in Steps S15, S16 has not been executed for all of the driving waveform candidates Wci to be measured in terms of the ejection characteristic, the procedure returns to Step S15. Then, one driving waveform candidate Wci for which the processing in Steps S15, S16 has not been executed is selected from among the plurality of driving waveform candidates Wci, and the processing in Steps S15, S16 is executed.

By repeating the processing in Steps S15, S16, the first acquisition processing to third acquisition processing is executed for each of the plurality of predetermined driving waveform candidates Wci. As a result, the first information Ii1 to third information Ii3 about the plurality of predetermined driving waveform candidates Wci associated with the same ink candidate Lci is stored in the memory 63 (Refer to the right region of the upper stage in FIG. 1). By executing the processing in Steps S11, S26b according to the first embodiment, the processing in Step S15 to S16b is executed for each of the plurality of ink candidates Lci previously prepared. A functional section of the CPU 62, which executes the processing in Steps S15 to S16b, is characteristic acquiring section 622.

In Step S21 in FIG. 6, the CPU 62 selects one driving waveform candidate Wci from among the plurality of driving waveform candidates Wci stored in the memory 63.

In Step S22b, the CPU 62 determines whether or not the ejection amount indicated by the first information Ii1, that is, the ejection amount corresponding to a combination of the ink candidate Lci selected in Step S11 performed last and the driving waveform candidate Wci selected in Step S21 performed last satisfies a second ejection amount condition. The second ejection amount condition is [Dw≤Thwb]. Thwb is a predetermined threshold, which is a positive number more than Thwa and less than Pwt.

The second ejection amount condition [Dw≤Thwb] may be expressed as follows:

[Pwt−Thwb]Pwm[Pwt+Thwb] (5)

That is, second ejection amount condition is that the ejection amount Pwm of the selected ink candidate Lci falls within a predetermined range [Pwt−Thwb] to [Pwt+Thwb]. By appropriately defining Thwb and executing the processing in Step S22b, the driving waveform achieving the desirable ejection amount can be selected.

In Step S22b, when the ejection amount satisfies the second ejection amount condition, the procedure returns to Step S23b. When the ejection amount does not satisfy the second ejection amount condition, the procedure returns to Step S21.

In Step S23b, the CPU 62 determines whether or not the ejection speed indicated by the second information Ii2, that is, the ejection speed corresponding to a combination of the ink candidate Lci selected in Step S11 performed last and the driving waveform candidates Wci selected in Step S21 performed last satisfies a second ejection speed condition. The second ejection speed condition is [Dv≤Thvb]. Thvb is a predetermined threshold, which is a positive number more than Thva and less than Pvt.

The second ejection speed condition [Dv≤Thvb] may be expressed as follows:

[Pvt−Thvb]Pvm[Pvt+Thvb] (6)

That is, the second ejection speed condition is that the ejection speed Pvm falls within a predetermined range [Pvt−Thvb] to [Pvt+Thvb]. By appropriately defining Thvb and executing the processing in Step S22b, the driving waveform achieving the desirable ejection speed can be selected.

In Step S22b, when the ejection speed satisfies the second ejection speed condition, the procedure returns to Step S23b. When the ejection speed does not satisfy the second ejection speed condition, the procedure returns to Step S21.

In Step S24, the CPU 62 determines whether or not a minimum value of the subdrop amount of the driving waveform candidates Wci selected in Step S21 performed after Step S11 performed last is updated. Specifically, it is determined whether or not the subdrop amount indicated by the third information Ii3, that is, the subdrop amount corresponding to a combination of the ink candidate Lci selected in Step S11 performed last and the driving waveform candidates Wci selected in Step S21 performed last is smaller than the previous minimum value of the subdrop amount. The previous minimum value of the subdrop amount is the minimum value of the subdrop amount of the group of driving waveform candidates Wci selected in Step S21 performed after Step S11 performed last. When the minimum value of the subdrop amount is updated, the CPU 62 associates the subdrop amount with the driving waveform candidate Wci and stores the subdrop amount as the minimum value of the subdrop amount in the memory 63. When the record of the minimum value of the subdrop amount is not updated, the previous minimum value of the subdrop amount and the driving waveform candidate Wci corresponding to the subdrop amount are maintained. In place of determining whether or not the minimum value of the subdrop amount of the driving waveform candidate Wci is updated in Step S24, it may be determined whether or not the subdrop amount of the driving waveform candidate Wci falls below a predetermined threshold.

In Step S25b, the CPU 62 determines whether or not the processing in Step S22b has been executed for all of the driving waveform candidates Wci. When the processing in Step S22b has been executed for all of the driving waveform candidates Wci, the procedure returns to Step S26. When the processing in Step S22b has not been executed for all of the driving waveform candidates Wci, the procedure returns to Step S21. In Step S21, one driving waveform candidate Wci for which the processing in Step S22b has not been executed is selected from among the plurality of driving waveform candidates Wci and then, the processing in Step S22b and subsequent steps is executed.

By repeatedly executing the processing in Steps S21 to S25b, among the plurality of predetermined driving waveform candidates Wci, the driving waveform candidates Wci in which the ejection amount indicated by the first information Ii1 satisfies the second ejection amount condition, the ejection speed indicated by the second information Ii2 satisfies the second ejection speed condition, and the subdrop amount indicated by the third information Ii3 is minimum is stored in the memory 63.

Note that at least one of Step S22b, Step S23b, and Step S24 only needs to be performed, and the other steps may be omitted.

In Step S26, the CPU 62 determines the driving waveform candidates Wci stored in the memory 63 as the driving waveform achieving the minimum value of the subdrop amount, as a corresponding driving waveform Wcs corresponding to the ink candidate Lci selected in Step S11 performed last.

The processing in Step S26b and subsequent steps in FIG. 6 is the same as the processing in Step S26b and subsequent steps in FIG. 5.

By executing the processing in Steps S11, S26b according to the first embodiment, for each of the plurality of ink candidates Lci previously prepared, one driving waveform candidate Wci is determined from among the plurality of driving waveform candidates Wci, based on the first information Ii1 to third information Ii3.

As a result, in Step S30, the ink to be ejected from the ink ejecting head 41 is selected based on the first information Ii1 to third information Ii3 corresponding to a combination of the corresponding driving waveform Wcs determined for each of the plurality of ink candidates Lci previously prepared and each of the plurality of ink candidates Lci (Refer to S31 to S35b in FIG. 5).

According to the second embodiment, the combination of the ink candidates Lci and the driving waveform candidate Wci, which achieves an excellent ejection characteristic when ejected from the ink ejecting head 41, can be selected as the combination of the ink to be ejected from the ink ejecting head 41 and the driving waveform applied to the ink ejecting head 41 from among combinations of the plurality of ink candidates Lci that can be replaced with each other when ejected from the ink ejecting head 41 and the plurality of driving waveform candidates Wci.

The processing in Step S26 according to this embodiment is also referred to as a “waveform determining step”.

According to this embodiment, although the corresponding driving waveform Wcs is determined providing that the ejection amount indicated by the first information Ii1 satisfies the second ejection amount condition in Step S22b, the corresponding driving waveform Wcs may be determined by optimization using the ejection amount indicated by the first information Ii1 as a parameter. For example, the driving waveform candidates Wci having a small ejection amount indicated by the first information Ii1 may be determined as the corresponding driving waveform Wcs. Similarly, the ejection speed indicated by the second information Ii2 in Step S23b may be optimized. In simultaneously optimizing a plurality of ejection characteristics (for example, ejection amount and ejection speed), multi-purpose optimization may be performed. Search processing in optimization may be automatically executed. One of the first information Ii1 and the second information Ii2 may be optimized and the other may be determined whether or not to satisfy the condition in Step S22b or S23b.

### C. Third Embodiment

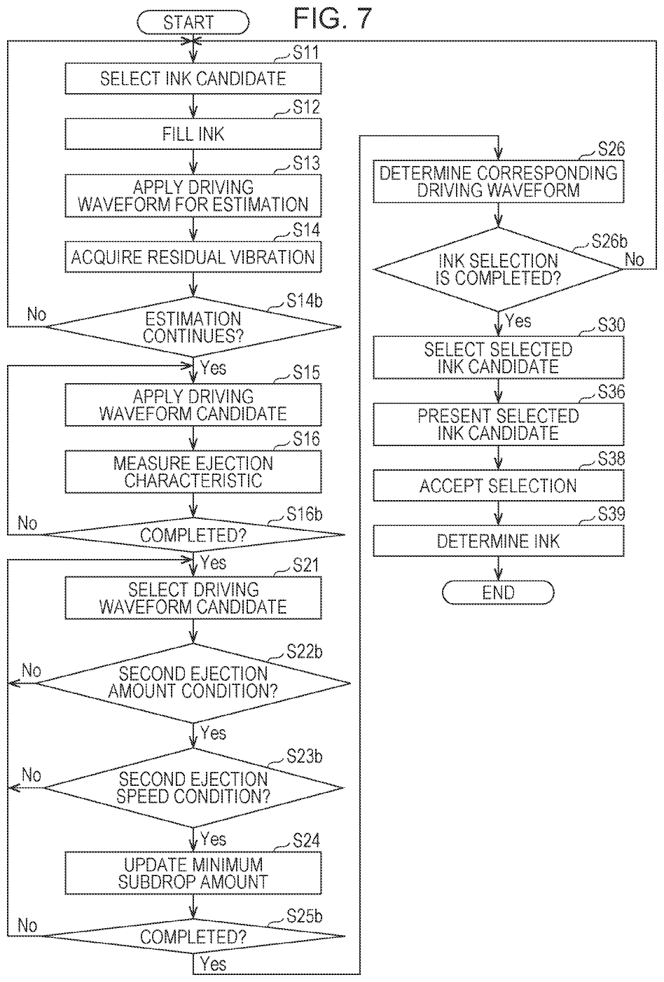

FIG. 7 is a flow chart illustrating a method of determining the ink to be applied to the printer 1 according to a third embodiment. The method in FIG. 7 corresponds to the method according to the first embodiment in FIG. 5 and the method according to the second embodiment in FIG. 6. According to third embodiment, the processing in Step S13 to 14b is executed between Step S12 and Step S15 in the method in FIG. 6. The remainder of the third embodiment is the same as that in the second embodiment.

In Step S13 in FIG. 7, the CPU 62 transmits a set of parameters indicating a predetermined driving waveform for estimation to the printer 1. According to this embodiment, the driving waveform for estimation is the driving waveform that vibrates a meniscus of the ink in the nozzle Nz so as not to eject ink drops from the nozzle Nz. The parameters indicating the driving waveform for estimation are previously stored in the memory 63 of the computer 60. The parameters indicating the driving waveform for estimation are included in the “waveform parameters 631” (Refer to the right region of the upper stage in FIG. 1).

In Step S13, the CPU 12 of the printer 1 controls the unit control circuit 14 to generate the driving signal COM, based on the set of parameters indicating the received driving waveform for estimation. Then, the CPU 12 applies the driving signal COM to the driving elements PZT of the ink ejecting head 41. The remainder of the processing in Step S13 is the same as that of the processing in Step S15 in FIG. 6.

In Step S14, the CPU 12 measures residual vibrations that occur in the ink in a pressure chamber 412d due to the driving of the driving elements PZT by the driving signal COM. Specifically, the CPU 12 measures a change in voltage occurring in the driving elements PZT after the second expanding element S5 of the driving waveform W, which is caused by the pressure change in the ink in the pressure chamber 412d (Refer to the center region of the lower stage in FIG. 3 and the right region of the lower stage in FIG. 4). The CPU 12 transmits data on the voltages to the computer 60.

The CPU 62 extracts a residual vibration signal NVT from the voltage data. The residual vibration signal NVT represents residual vibrations occurring after a driving signal is applied to the driving elements PZT. The residual vibrations are vibrations having natural frequency determined depending on the flow channel resistance of the ink flow channel in the head unit 40, the inertance of ink in the ink flow channel, elastic compliance of the elastic film 412i. The CPU 62 associates information about the parameters indicating a characteristic of the residual vibration signal NVT for the ink candidate Lci with information identifying the ink candidate Lci, and stores the information in the memory 63. The information about the parameters of the residual vibration signal NVT is referred to as “vibration information Irv”.

The vibration information Irv indicates an characteristic of the residual vibration of liquid in the ink ejecting head 41 when a certain driving waveform W is applied to the driving elements PZT of the ink ejecting head 41. The processing of acquiring the vibration information Irv in Steps S13, S14 is referred to as “vibration acquisition processing” in this specification.

A functional section of CPU 62, which executes the processing in Steps S13, S14, is the characteristic acquiring section 622 (Refer to the central region of the upper stage in FIG. 1).

In Step S14b, the CPU 62 determines whether or not the characteristic of the ink candidate Lci satisfies a predetermined condition, based on the parameters of the vibration information Irv. The predetermined condition defines whether or not estimation should be continued in Step S15 and subsequent steps. Specifically, the predetermined condition is a condition related to the viscosity, surface tension, or the like of the ink candidate Lci. Such condition is defined as a condition for preventing an ink ejecting failure, that is, a condition that the ejection characteristic acquired in Step S16 is close to a target value to a certain extent.

In Step S14b, when the characteristic of the ink candidate Lci, which is indicated by the vibration information Irv, satisfies the condition, the procedure returns to Step S15. When the characteristic of the ink candidate Lci, which is indicated by the vibration information Irv, does not satisfy the condition, the procedure returns to Step S11. When the characteristic of the ink candidate Lci, which is indicated by the vibration information Irv, does not satisfy the condition, the processing in Step S15 and subsequent steps is not executed for the ink candidate Lci selected in immediately prior Step S11.

The processing in Step S15b and subsequent steps in FIG. 7 is the same as the processing in Step S15 and subsequent steps in FIG. 6.

By executing the processing in Steps S11, S26b according to the first embodiment, the processing in Steps S13, S14 is executed for each of the plurality of ink candidates Lci previously prepared. As a result, based on the vibration information Irv and the plurality of ink candidates Lci previously prepared, the ink candidates Lci to be subjected to the processing in Step S15 and subsequent steps is selected from among the plurality of ink candidates Lci previously prepared.

According to third embodiment, prior to the processing in Step S30, selection is made for the plurality of ink candidates Lci previously prepared according to the predetermined condition (Refer to S14b in FIG. 7). As a result, in Step S30, an ink to be ejected from the ink ejecting head 41 is selected based on a part of the plurality of ink candidates Lci previously prepared.

According to the third embodiment, the ink candidate that is unlikely to be the liquid to be ejected from the ink ejecting head 41 can be excluded from the ink candidates to be subjected to the processing in Steps S15, S16b, based on the vibration information Irv. For this reason, the time required to determine the ink to be applied to the printer 1 and the amount of ink consumed to this end can be reduced.

According to this embodiment, the plurality of ink candidates Lci previously prepared to be processed in Steps S13, S14 are also referred to as “second liquid candidates”. The ink candidates Lci to be subjected to the processing in Steps S15, S16 is also referred to as a “first liquid candidate”. Step S14 is also referred to as a “vibration acquiring step”. Step S14b is also referred to as a “preliminary selecting step”.

### D. Further Embodiments

### D1. Further Embodiment 1

(1) According to the first embodiment, the plurality of ink candidates Lci are a plurality of inks supplied as a “cyan ink” by a plurality of manufacturers. However, the ink candidates may be inks of yellow, black, red, green, clear, or any other color. Though, the plurality of ink candidates Lci are preferably inks that can be replaced with each other to reproduce the same color.

(2) According to the first embodiment, in Step S12 in FIG. 5, the user attaches a cartridge of the selected ink to the carriage 31, and fills the ink into the nozzles Nz of the ink ejecting head 41. Then, each time the processing in Steps S11, S12 is executed, in Step S15, the same nozzles are used to eject different inks. However, cartridges of the plurality of ink candidates Lci previously prepared can be simultaneously attached to the carriage 31, following processing may be executed.

After the ink candidate Lci is selected in Step S11, the CPU 12 of the printer 1 ejects ink drops from the nozzles that can supply the selected ink candidate Lci in Step S15. Then, in Step S16, the CPU 62 acquires the ejection characteristic of the ejected ink drops. When the printer 1 includes the plurality of the ink ejecting heads 41, the nozzles for ejecting ink drops may be nozzles of the different ink ejecting heads 41. From such aspect, according to the method in FIG. 5, the processing in Step S12 performed after Step S11 is omitted.

When a plurality of the printer 1 of the same model are interconnected via a network, cartridges of the plurality of ink candidates Lci previously prepared may be attached to the different printers 1, and ink drops may be ejected from the nozzles of the different printers 1 to acquire the ejection characteristic.

(3) According to the first embodiment, the ejection amount Pwm is estimated based on an image captured by using the CCD camera 55. However, the ejection amount Pwm may be measured using a scale.

(4) According to the first embodiment, an ink to be ejected from the ink ejecting head 41 are selected based on the first information Ii1 about the ejection amount Pwm, the second information Ii2 about the ejection speed Pvm, and the third information Ii3 about the subdrop amount Psm (Refer to S32b to S34b in FIG. 5). However, in selecting the ink to be ejected from the ink ejecting head 41, one or more of the estimating parameters may not be considered. In selecting one or more liquids to be ejected from the liquid ejecting head, the liquids may be selected based on information indicating some ejection characteristic of the liquid ejected from the liquid ejecting head when the driving waveform is applied to the driving elements of the liquid ejecting head.

(5) According to the third embodiment, in the processing in Step S14 in FIG. 7, the driving elements are driven and the residual vibrations are measured. In the processing in Step S16, ink drops are ejected and the ejection characteristic is measured. However, for example, when at least a portion of the first information Ii1 to third information Ii3 and the vibration information Irv is stored in the memory 63 of the computer 60 or the memory 13 of the printer 1, the driving waveform or ink may be determined based on the stored information.

(6) According to the first embodiment, in repeatedly performed Step S35, the selected ink Iks is determined from among the plurality of ink candidates Lci previously prepared. The selected ink Iks is presented to the user (Refer to in S36 in FIG. 5). The ink candidates Lci constituting the selected ink Iks may be one ink or a plurality of inks. The number of ink candidates Lci constituting the selected ink Iks is determined based on contents of the plurality of ink candidates Lci previously prepared, as well as the first ejection amount condition, the first ejection speed condition, and the subdrop amount condition.

(7) According to the second embodiment, in Step S22b in FIG. 6, it is determined whether or not the second ejection amount condition is satisfied, and in Step S23b, whether or not the second ejection speed condition is satisfied. Then, in Step S24, among the driving waveform candidates Wci that satisfy these conditions, the driving waveform candidate Wci having the minimum subdrop amount is determined as the corresponding driving waveform Wcs corresponding to the ink candidate Lci selected in Step S11.

However, the subdrop amount Psm can be adopted as the parameter defining a constraint. The ejection amount Pwm and the ejection speed Pvm can be adopted as the parameters that are indicators for selecting the optimum corresponding driving waveform Wcs.

In a solution space defined by a plurality of estimation parameters, a plurality of driving waveform candidates Wci that are Pareto optimal solutions may be presented to the user and the user's selection of the driving waveform candidates Wci may be accepted. Further, the driving waveform candidate Wci that minimizes or maximizes a predetermined objective function including a plurality of estimation parameters may be determined as the corresponding driving waveform Wcs.

(8) According to the third embodiment, the driving waveform for estimation is the driving waveform that vibrates the meniscus of the ink in the nozzle Nz so as not to eject ink drops from the nozzle Nz (Refer to S13 in FIGS. 7 and 3). However, the driving waveform for estimation may be the driving waveform with which ink drops are ejected from the nozzles Nz. Though, the driving waveform for estimation is preferably the driving waveform that results in a smaller ink ejection amount than the driving waveform candidate Wci applied in Step S15 in FIG. 7. From such aspect, the amount of the ink consumed to determine the ink to be applied to the printer 1 can be further reduced.

(9) According to the third embodiment, as a result of the processing in Steps S13 to S14b in FIG. 7, the ink candidates Lci to be subjected to the processing in Step S15 and subsequent steps is selected from among the plurality of ink candidates Lci previously prepared, based on the vibration information Irv and the plurality of ink candidates Lci previously prepared. However, prior to the processing in Step S13, the ink candidate may be further selected from among the plurality of ink candidates Lci previously prepared according to a predetermined condition. From such aspect, in Step S14b, the ink candidates Lci to be subjected to the processing in Step S15 and subsequent steps is selected from among the plurality of ink candidates Lci, based on some of the plurality of ink candidates Lci previously prepared.

(10) According to the above embodiment, the liquid ejecting apparatus is the printer that ejects the ink. However, the liquid ejecting apparatus may be any other apparatus such as an apparatus for manufacturing an electronic device.

(11) According to the above embodiment, the first information Ii1 and the second information Ii2 is information indicating the ejection characteristic. However, the first information and the second information may not information indicating the ejection characteristic itself. That is, the first information and the second information may be information related to the ejection characteristic itself.

(12) According to the above embodiment, the vibration information Irv is information about parameters of the residual vibration signal NVT. However, the vibration information may not information indicating a residual vibration itself. That is, the vibration information only needs to be information related to the residual vibration.

### D2. Further Embodiment 2

In processing in Step S30 in a modification example of the first embodiment, the ink to be ejected from the ink ejecting head 41 is selected based on the individual information Ie1, Ie2 associated with each of the plurality of ink candidates Lci (Refer to the right region of the upper stage in FIG. 1). However, one or more inks to be ejected from the ink ejecting head 41 may be selected based on the information indicating the ejection characteristic, not on the individual information.

### D3. Further Embodiment 3

In a modification example of the first embodiment, the individual information Ie1 includes information indicating costs of the associated ink candidates Lci (Refer to the right region of the upper stage in FIG. 1). However, the individual information may be information including no information about costs. Then, individual information may be information for estimation of the ink candidate Lci by the purchaser, like the individual information Ie2.

### D4. Further Embodiment 4

In a modification example of the first embodiment, the individual information Ie2 includes information indicating an estimation of the associated ink candidates Lci, except for the ejection characteristic (Refer to the right region of the upper stage in FIG. 1). However, the individual information may be information including no information indicating estimation other than the ejection characteristic. Then, the individual information is, for example, as represented as the individual information Ie1, information indicating costs of the ink candidates Lci.

### D5. Further Embodiment 5

According to the first embodiment, in Step S35 in FIG. 5, the ink to be ejected from the ink ejecting head 41 is selected based on the second information Ii2 and the third information Ii3 in addition to the first information Ii1. However, the ink to be the ink to be ejected from the ink ejecting head 41 may be selected based on one, two, or four more types of ejection characteristics.

### D6. Further Embodiment 6

According to the third embodiment, in Step S30, the ink to be ejected from the ink ejecting head 41 is selected based on the first information Ii1 to third information Ii3 corresponding to the combination of the corresponding driving waveform Wcs determined for each of the plurality of ink candidates Lci previously prepared and each of the plurality of ink candidates Lci (Refer to S30 in FIG. 7 and S31 to S35b in FIG. 5).

However, the ink to be ejected from the ink ejecting head 41 may be determined based on the ejection characteristic of one driving waveform candidate Wci as in the first embodiment, not on the corresponding driving waveform Wcs selected from among the plurality of driving waveform candidates Wci.

### D7. Further Embodiment 7

According to the third embodiment, when it is determined based on the parameters of the vibration information Irv that the characteristic of the ink candidate Lci does not satisfy the predetermined condition, the processing in Step S15 and subsequent steps is not executed for the ink candidate Lci selected in immediately prior Step S11 (Refer to S14b in FIG. 7). However, as described in the first embodiment and the second embodiment, the acquiring step may be performed for all of the plurality of ink candidates Lci previously prepared to select the ink to be ejected from the ink ejecting head 41.

### D8. Further Embodiment 8

In Step S36 in the first embodiment, the CPU 62 outputs information indicating one or more ink candidates Lci to be ejected from the ink ejecting head 41 selected in Step S30 (Refer to S36 in FIG. 5). However, the processor does not output information indicating the ink candidates Lci, and may determine the ink estimated the highest according to a predetermined reference as the ink to be ejected from the ink ejecting head 41, without receiving the user's selection.

### D9. Further Embodiment 9

The ejection amount Pwm, the ejection speed Pvm, and the subdrop amount Psm are adopted as parameters indicating the ejection characteristics (Refer to Ii1, Ii2, Ii3 in the right region of the upper stage in FIG. 1). However, other parameters such as a displacement in hit position of ink drops in the main scanning direction and/or subscanning direction may be determined as the parameters indicating the ejection characteristics.

### E. Still Further Embodiments

The present disclosure is not limited to the above-described embodiments, and may be realized in various embodiments so as not deviate from the subject matter. For example, the present disclosure can be realized as following embodiments. In order to resolve some or all problems of the present disclosure or achieve some or all effects of the present disclosure, the technical features in the above-mentioned embodiments, which correspond to technical features in each of below-mentioned embodiments can be appropriately replaced or combined. In addition, when the technical feature is not described as being essential in this specification, it can be omitted as appropriate.

(1) An embodiment of the present disclosure provides a liquid selecting method of selecting a liquid to be ejected from a liquid ejecting head. The liquid selecting includes: an acquiring step of executing, for each of a plurality of first liquid candidates, first acquisition processing of acquiring first information about a first ejection characteristic of a liquid when a driving waveform is applied to a driving element of the liquid ejecting head; and a liquid selecting step of selecting, based on the first information and at least some of the plurality of first liquid candidates, one or more liquids to be ejected from the liquid ejecting head.

From such aspect, among the plurality of first liquid candidates that can be replaced with each other when ejected from the liquid ejecting head, the first liquid candidate having the excellent first ejection characteristic when ejected from the liquid ejecting head can be selected as the liquid to be ejected from the liquid ejecting head.

(2) Preferably, in the above-described liquid selecting method, the liquid selecting step further includes selecting, based on individual information associated with corresponding one of the at least some of the plurality of first liquid candidates, the one or more liquids to be ejected from the liquid ejecting head.

From such aspect, the liquid to be ejected from the liquid ejecting head may be selected in consideration of information other than the first ejection characteristic.

(3) Preferably, in the above-described liquid selecting method, the individual information includes information indicating a cost of the corresponding one of the first liquid candidates.

From such aspect, the liquid to be ejected from the liquid ejecting head can be selected in consideration of costs of the first liquid candidates.

(4) Preferably, in the above-described liquid selecting method, the individual information includes information indicating an estimation of the corresponding one of the first liquid candidates.

From such aspect, the liquid to be ejected from the liquid ejecting head can be selected in consideration of estimation other than the first ejection characteristic of the first liquid candidate.

(5) Preferably, in the above-described liquid selecting method, the acquiring step includes executing, for each of the plurality of first liquid candidates, second acquisition processing of acquiring second information about a second ejection characteristic of a liquid when the driving waveform is applied to the driving element of the liquid ejecting head, the second ejection characteristic differs from the first ejection characteristic, and the liquid selecting step further includes selecting, based on the second information, the one or more liquids to be ejected from the liquid ejecting head.

From such aspect, among the plurality of first liquid candidates that can be replaced with each other when ejected from the liquid ejecting head, the first liquid candidate having the excellent second ejection characteristic when ejected from the liquid ejecting head can be selected as the liquid to be ejected from the liquid ejecting head.

(6) Preferably, in the above-described liquid selecting method, the acquiring step includes executing, for each of the plurality of first liquid candidates, the first acquisition processing for each of a plurality of driving waveform candidates as the driving waveform, the liquid selecting method further includes a waveform determining step of determining, for each of the plurality of first liquid candidates, based on the first information, one driving waveform candidate from among the plurality of driving waveform candidates, and the liquid selecting step is a step of selecting, based on the first information corresponding to a combination of the driving waveform candidate determined for each of at least some of the plurality of first liquid candidates and corresponding one the at least some of the plurality of first liquid candidates, the one or more liquids to be ejected from the liquid ejecting head.

From such aspect, the combination of the first liquid candidate and the waveform candidate, which achieves an excellent ejection characteristic when ejected from the ink ejecting head, can be selected as the combination of the liquid to be ejected from the liquid ejecting head and the driving waveform applied to the ink ejecting head from among combinations of the plurality of ink candidates Lci that can be replaced with each other when ejected from the ink ejecting head and the plurality of waveform candidates.

(7) Preferably, in the above-described liquid selecting method, the liquid selecting method further includes: a vibration acquiring step of performing vibration acquisition processing for each of a plurality of second liquid candidates, the vibration acquisition processing is processing of acquiring vibration information about a residual vibration of the liquid in the liquid ejecting head when the driving waveform is applied to the driving element of the liquid ejecting head; and a preliminary selecting step of selecting, based on the vibration information and at least some of the plurality of second liquid candidates, the plurality of first liquid candidates from among the plurality of second liquid candidates.

From such aspect, the plurality of first liquid candidates to be subjected to the acquiring step can be determined from among the plurality of second liquid candidates based on the vibration information. Thus, the liquid candidate that is unlikely to be the liquid to be ejected from the liquid ejecting head can be excluded from targets to be processed in the acquiring step based on the vibration information.

(8) Preferably, in the above-described liquid selecting method, the liquid selecting method further includes a presenting step of presenting, to a user, information indicating the one or more liquids to be ejected from the liquid ejecting head, the liquids being selected in the liquid selecting step.

From such aspect, one or more liquids can be presented as candidates for the liquid to be ejected from the liquid ejecting head to the user.

(9) Preferably, in the above-described liquid selecting method, the first ejection characteristic is an ejection amount of the liquid ejected by an ejecting operation of the driving element.

From such aspect, the liquid candidate having a preferable ejection amount of the liquid ejected from the nozzles can be selected as the liquid to be ejected from the liquid ejecting head.

(10) Preferably, in the above-described liquid selecting method, the second ejection characteristic is an ejection speed of the liquid ejected from the liquid ejecting head.

From such aspect, the liquid candidate having a preferable ejection speed of the liquid ejected from the nozzles can be selected as the liquid to be ejected from the liquid ejecting head.

(11) Another embodiment of the present disclosure provides a non-transitory computer-readable storage medium storing a computer program, the computer program causing a computer to perform the liquid selecting method according to any one of the above-described embodiments.

(12) Still another embodiment of the present disclosure provides a liquid ejecting apparatus. The liquid ejecting apparatus includes a liquid ejecting head that includes a driving element driven by application of a driving signal and ejects a liquid by the driving element being driven; a driving control section that controls the liquid ejecting head; a characteristic acquiring section that executes, for each of a plurality of first liquid candidates, first acquisition processing of acquiring first information about a first ejection characteristic of a liquid when a driving waveform is applied to the driving element of the liquid ejecting head; and one or more liquid selecting sections that selects, based on the first information and at least some of the plurality of first liquid candidates, liquid to be ejected from the liquid ejecting head.

The present disclosure can be embodied as various forms other than the liquid selecting method, the liquid ejecting apparatus, and the computer program that performs the liquid selecting method. For example, the present disclosure can be embodied as a liquid ejecting apparatus control method, a computer program that implements the control method, and a nontemporary recording medium. In addition, although the printer 1 has been described in the embodiments, a printer may not be used in the liquid ejecting apparatus, and a so-called experiment apparatus or estimating apparatus may be instead used as long as it has a function of ejecting liquid.

What is claimed is:

1. A liquid selecting method of selecting a liquid to be ejected from a liquid ejecting head, the method comprising:
an acquiring step of executing, for each of a plurality of first liquid candidates, first acquisition processing of acquiring first information about a first ejection characteristic of a liquid when a driving waveform is applied to a driving element of the liquid ejecting head; and
a liquid selecting step of selecting, based on the first information and at least some of the plurality of first liquid candidates, one or more liquids to be ejected from the liquid ejecting head.

2. The liquid selecting method according to claim 1, wherein the liquid selecting step further includes selecting, based on individual information associated with corresponding one of the at least some of the plurality of first liquid candidates, the one or more liquids to be ejected from the liquid ejecting head.

3. The liquid selecting method according to claim 2, wherein the individual information includes information indicating a cost of the corresponding one of the first liquid candidates.

4. The liquid selecting method according to claim 2, wherein the individual information includes information indicating an estimation of the corresponding one of the first liquid candidates.

5. The liquid selecting method according to claim 1, wherein
the acquiring step includes
executing, for each of the plurality of first liquid candidates, second acquisition processing of acquiring second information about a second ejection characteristic of a liquid when the driving waveform is applied to the driving element of the liquid ejecting head,
the second ejection characteristic differs from the first ejection characteristic, and
the liquid selecting step further includes selecting, based on the second information, the one or more liquids to be ejected from the liquid ejecting head.

6. The liquid selecting method according to claim 1, wherein
the acquiring step includes executing, for each of the plurality of first liquid candidates, the first acquisition processing for each of a plurality of driving waveform candidates as the driving waveform,
the liquid selecting method further comprises a waveform determining step of determining, for each of the plurality of first liquid candidates, based on the first information, one driving waveform candidate from among the plurality of driving waveform candidates, and
the liquid selecting step is a step of selecting, based on the first information corresponding to a combination of the driving waveform candidate determined for each of at least some of the plurality of first liquid candidates and corresponding one of the at least some of the plurality of first liquid candidates, the one or more liquids to be ejected from the liquid ejecting head.

7. The liquid selecting method according to claim 1, further comprising:
a vibration acquiring step of performing vibration acquisition processing for each of a plurality of second liquid candidates, the vibration acquisition processing being processing of acquiring vibration information about a residual vibration of the liquid in the liquid ejecting head when the driving waveform is applied to the driving element of the liquid ejecting head; and
a preliminary selecting step of selecting, based on the vibration information and at least some of the plurality of second liquid candidates, the plurality of first liquid candidates from among the plurality of second liquid candidates.

8. The liquid selecting method according to claim 1, further comprising a presenting step of presenting, to a user, information indicating the one or more liquids to be ejected from the liquid ejecting head, the liquids being selected in the liquid selecting step.

9. The liquid selecting method according to claim 1, wherein the first ejection characteristic is an ejection amount of the liquid ejected by an ejecting operation of the driving element.

10. The liquid selecting method according to claim 5, wherein the second ejection characteristic is an ejection speed of the liquid ejected from the liquid ejecting head.

11. A non-transitory computer-readable storage medium storing a computer program, the computer program causing a computer to perform the liquid selecting method according to claim 1.

12. A liquid ejecting apparatus comprising:
a liquid ejecting head that includes a driving element driven by application of a driving signal and ejects a liquid by the driving element being driven;
a driving control section that controls the liquid ejecting head;
a characteristic acquiring section that executes, for each of a plurality of first liquid candidates, first acquisition processing of acquiring first information about a first ejection characteristic of a liquid when a driving waveform is applied to the driving element of the liquid ejecting head; and
a liquid selecting section that selects, based on the first information and at least some of the plurality of first liquid candidates, one or more liquids to be ejected from the liquid ejecting head.
